(19) United States
(12) Patent Application Publication
(10) Pub. No.: US 2010/0017070 A1
(43) Pub. Date: Jan. 21, 2010

(54) STABILITY CONTROL AND INCLINED SURFACE CONTROL USING A COMMON SIGNAL SOURCE

(75) Inventors: Jeffrey Allen Doering, Canton, MI (US); Michael Glenn Fodor, Dearborn, MI (US); Eric Tseng, Canton, MI (US)

Correspondence Address: ALLEMAN HALL MCCOY RUSSELL & TUTTLE, LLP, 806 S.W. BROADWAY, SUITE 600, PORTLAND, OR, 97205, US

(73) Assignee: FORD GLOBAL TECHNOLOGIES, LLC, Dearborn, MI (US)

(21) Appl. No.: 12/173,281

(22) Filed: Jul. 15, 2008

(51) Int. Cl. B60T 8/24

(52) U.S. Cl. 701/48; 701/36; 701/70; 701/1

(57) ABSTRACT

A method and system are disclosed for controlling a vehicle. The method includes adjusting a first actuator to increase vehicle stability during vehicle traveling conditions, the actuator adjusted in response to a vehicle acceleration sensor. The method also includes adjusting a second actuator to maintain vehicle position during stopped vehicle conditions on an inclined surface, the second actuator adjusted in response to the vehicle acceleration sensor.

### BACKGROUND/SUMMARY

Some vehicles, in particular vehicles equipped with an automatic transmission, may be equipped with a hill holding control feature to prevent or reduce rollback until the engine is fully engaged with the transmission to move the vehicle forward. The hill holding control may include a brake control configured to apply brakes to the wheels of the vehicle until the engine provides enough torque to begin moving the vehicle forward. However, if the brakes are applied for too long, or with too much force, the engine competes with the brake force and fuel may be wasted. In order to reduce fuel loss, the brake force applied, or the length of time the brakes are applied may be adjusted according to a degree of incline of the hill.

Vehicles may also be equipped with a downhill control feature in order to avoid excess speed when traveling down an incline. The downhill control feature may implement actions such as applying the brakes, and reducing engine torque to use engine inertia to slow the vehicle. Downhill control typically applies right and left brakes equally to slow the vehicle. The amount of downhill control may also be adjusted according to the degree of incline.

Some vehicles may be equipped with Electronic Stability Control (ESC) to increase vehicle stability. In recent years control features have been added to vehicles to decrease the likelihood of a vehicle rollover. These features may be referred to as Roll Stability Control or RSC®, a registered trademark of the Ford Motor Corporation. RSC may monitor the vehicle's stability using a number of sensors configured to sense the physical disposition of the vehicle such as the roll angle and roll rate of the vehicle, and then take corrective action that may include reducing engine torque and/or braking one or more wheels.

However, rollover conditions may be rare. On the other hand, driving on, or stopping on, an incline may be more common. Thus the inventors herein have recognized various approaches that enable system integration. For example, a method, apparatus, and a system that provides an efficient arrangement of a vehicle inclination sensor that may be used, where the sensor provides inclination data for RSC, hill-holding and/or downhill control. The method, apparatus, and a system may also provide logic that may increase the performance features of the RSC so that they take precedence over the hill-holding and/or downhill control.

It should be understood that the summary above is provided to introduce in simplified form a selection of concepts that are further described in the detailed description. It is not meant to identify key or essential features of the claimed subject matter, the scope of which is defined uniquely by the claims that follow the detailed description. Furthermore, the claimed subject matter is not limited to implementations that solve any disadvantages noted above or in any part of this disclosure.

### BRIEF DESCRIPTION OF DRAWINGS

FIG. 1 shows a schematic depiction of one cylinder in an internal combustion engine configured to propel a vehicle.

FIG. 2 shows a schematic depiction of the vehicle having sensors to provide input to a vehicle controller and actuators that may be configured to actuate certain control operations to control the vehicle in accordance with the input.

FIG. 3 shows a schematic depiction of vehicle wheels and brakes with the vehicle controller configured to control the propulsion and braking of the vehicle.

FIGS. 4-6 illustrate example details of various vehicle controllers.

FIG. 7 is a schematic flow diagram illustrating example ways the signal from a vehicle inclination sensor may be conditioned according to various embodiments.

FIGS. 8A through 11B are pairs of figures illustrating example driving conditions schematically as inputs, and example signal outputs in graphical form.

FIGS. 12 through 17 illustrate various methods to control vehicle stability and to provide vehicle control on an incline.

### DETAILED DESCRIPTION

A vehicle system, for an engine propelled vehicle, is described having an inclined surface control, and an electronic vehicle stability control (ESC), such as roll stability control (RSC), that may both receive input from a common vehicle inclination sensor.

The inclined surface control may include a hill holding feature and a downhill control feature. The hill holding feature may be implemented in the case of the vehicle starting up an incline from a stop, or near stop, and may selectively activate a braking mechanism until the engine torque is above a predetermined threshold to move the vehicle forward and up the incline without any significant rollback. The braking mechanism may be configured to brake one or more wheels on the respective right side and left side of the vehicle substantially equally.

The downhill control feature may be implemented in the case of the vehicle moving downhill, and may be used to control vehicle speed. The downhill control feature may also activate the braking mechanism, and may, in addition, control the engine to limit torque to control the downhill speed of the vehicle. The braking mechanism may also be configured to brake one or more wheels on the respective right side and left side of the vehicle substantially equally.

In both cases, the hill holding and downhill control, the desired amount of braking and engine control may be a function of a degree of inclination of the vehicle. Accordingly, the vehicle may include a vehicle inclination sensor, such as a longitudinal accelerometer, configured to provide output to the braking mechanism, and to an engine controller to control engine torque.

The RSC may include a number of sensors configured to monitor the disposition of the vehicle. The sensors may be used to provide input to automate control of one or more vehicle brakes to reduce a roll tendency of the vehicle during turning, or other, conditions. In various embodiments, the vehicle inclination sensor used for the inclined surface vehicle control may also be used for the RSC. Alternatively the vehicle inclination sensor used for the RSC may also be used for the inclined surface vehicle control.

In various embodiments, the sensor information from the vehicle inclination sensor may be processed through a filter and/or modified based on other sensor information to more accurately reflect the relevant data for the particular control feature. For example, accelerometer data from a longitudinal sensor at low frequencies can be used to identify road grade, whereas data from the sensor in a broader range of frequencies may be used to control vehicle stability, such as for roll stability control.

The inventors have recognized that, depending on the disposition of the vehicle, the signal from the vehicle inclination sensor may have decipherable characteristics indicative of the type of motion the vehicle is experiencing. For example, a signal detected from the vehicle inclination sensor during conditions wherein a rollover may be possible may change more rapidly, whereas a signal detected from the vehicle inclination sensor when traveling downhill, or stopped on an uphill grade, or when moving from one incline to another, may change more slowly. Specifically, the relatively more dynamic nature of a rollover condition when compared to a downhill traverse. Similarly, the signal detected from vehicle inclination sensor when the vehicle is stopped on an incline may also change more slowly than rollover conditions. Accordingly, by appropriately filtering and/or modifying the signal differently for the various different control operations, the same sensor signal may be used to affect both RSC and inclined surface control.

In addition, the vehicle inclination sensor may pick up signal components from road surface irregularities and/or engine vibrations. These signal components may be filtered out from the vehicle inclination sensor signal for use with both the inclined surface control, and the RSC.

Further, various embodiments may use signals from sensors other than the vehicle inclination sensor to more accurately reflect the type of motion the vehicle is experiencing. For example, signals from sensors that may include, but may not be limited to, a longitudinal acceleration sensor, a latitudinal acceleration sensor, a yaw sensor, and the like.

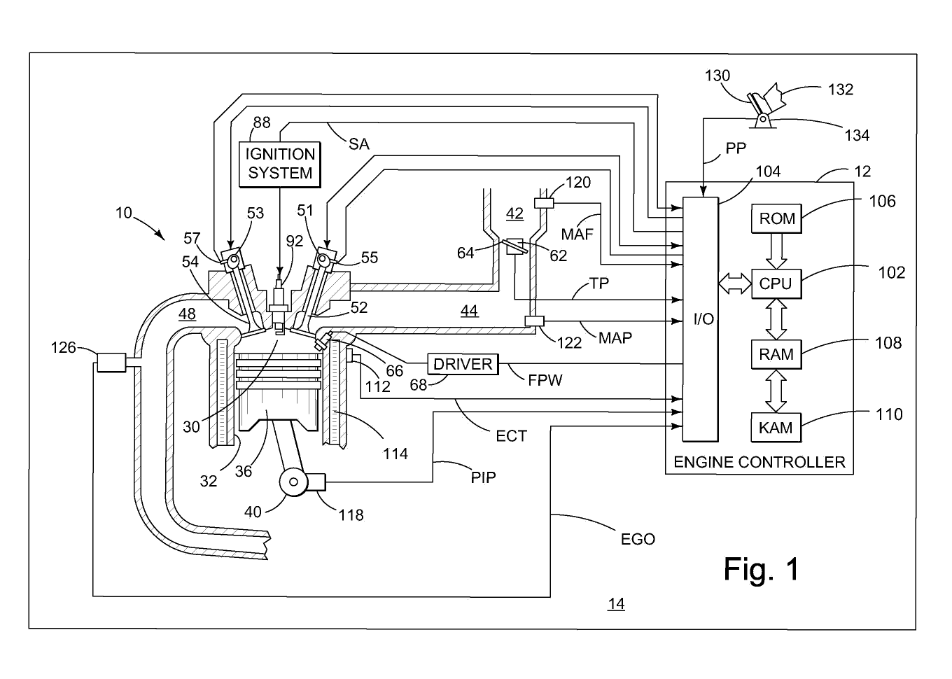

Referring now to FIG. 1, it shows a schematic diagram showing one cylinder of multi-cylinder engine 10, which may be included in a propulsion system of a vehicle 14. Engine 10 may be controlled at least partially by a control system including controller 12 and by input from a vehicle operator 132 via an input device 130. In this example, input device 130 includes an accelerator pedal and a pedal position sensor 134 for generating a proportional pedal position signal PP. Combustion chamber (i.e. cylinder) 30 of engine 10 may include combustion chamber walls 32 with piston 36 positioned therein. Piston 36 may be coupled to crankshaft 40 so that reciprocating motion of the piston is translated into rotational motion of the crankshaft. Crankshaft 40 may be coupled to at least one drive wheel of a vehicle via an intermediate transmission system. Further, a starter motor may be coupled to crankshaft 40 via a flywheel to enable a starting operation of engine 10.

Combustion chamber 30 may receive intake air from intake manifold 44 via intake passage 42 and may exhaust combustion gases via exhaust passage 48. Intake manifold 44 and exhaust passage 48 can selectively communicate with combustion chamber 30 via respective intake valve 52 and exhaust valve 54. In some embodiments, combustion chamber 30 may include two or more intake valves and/or two or more exhaust valves.

In this example, intake valve 52 and exhaust valves 54 may be controlled by cam actuation via respective cam actuation systems 51 and 53. Cam actuation systems 51 and 53 may each include one or more cams and may utilize one or more of cam profile switching (CPS), variable cam timing (VCT), variable valve timing (VVT) and/or variable valve lift (VVL) systems that may be operated by controller 12 to vary valve operation. The position of intake valve 52 and exhaust valve 54 may be determined by position sensors 55 and 57, respectively. In alternative embodiments, intake valve 52 and/or exhaust valve 54 may be controlled by electric valve actuation. For example, cylinder 30 may alternatively include an intake valve controlled via electric valve actuation and an exhaust valve controlled via cam actuation including CPS and/or VCT systems.

Fuel injector 66 is shown coupled directly to combustion chamber 30 for injecting fuel directly therein in proportion to the pulse width of signal FPW received from controller 12 via electronic driver 68. In this manner, fuel injector 66 provides what is known as direct injection of fuel into combustion chamber 30. The fuel injector may be mounted in the side of the combustion chamber or in the top of the combustion chamber, for example. Fuel may be delivered to fuel injector 66 by a fuel delivery system (not shown) including a fuel tank, a fuel pump, and a fuel rail. In some embodiments, combustion chamber 30 may alternatively or additionally include a fuel injector arranged in intake passage 44 in a configuration that provides what is known as port injection of fuel into the intake port upstream of combustion chamber 30.

Intake passage 42 may include a throttle 62 having a throttle plate 64. In this particular example, the position of throttle plate 64 may be varied by controller 12 via a signal provided to an electric motor or actuator included with throttle 62, a configuration that is commonly referred to as electronic throttle control (ETC). In this manner, throttle 62 may be operated to vary the intake air provided to combustion chamber 30 among other engine cylinders. The position of throttle plate 64 may be provided to controller 12 by throttle position signal TP. Intake passage 42 may include a mass air flow sensor 120 and a manifold air pressure sensor 122 for providing respective signals MAF and MAP to controller 12.

Ignition system 88 can provide an ignition spark to combustion chamber 30 via spark plug 92 in response to spark advance signal SA from controller 12, under select operating modes. Though spark ignition components are shown, in some embodiments, combustion chamber 30 or one or more other combustion chambers of engine 10 may be operated in a compression ignition mode, with or without an ignition spark.

Exhaust gas sensor 126 is shown coupled to exhaust passage 48. Sensor 126 may be any suitable sensor for providing an indication of exhaust gas air/fuel ratio such as a linear oxygen sensor or UEGO (universal or wide-range exhaust gas oxygen), a two-state oxygen sensor or EGO, a HEGO (heated EGO), a NOx, HC, or CO sensor.

Controller 12 is shown in FIG. 1 as a microcomputer, including microprocessor unit 102, input/output ports 104, an electronic storage medium for executable programs and calibration values shown as read only memory chip 106 in this particular example, random access memory 108, keep alive memory 110, and a data bus. Storage medium read-only memory 106 can be programmed with computer readable data representing instructions executable by processor 102 for performing the methods described below as well as other variants that are anticipated but not specifically listed. Controller 12 may receive various signals from sensors coupled to engine 10, in addition to those signals previously discussed, including measurement of inducted mass air flow (MAF) from mass air flow sensor 120; engine coolant temperature (ECT) from temperature sensor 112 coupled to cooling sleeve 114; a profile ignition pickup signal (PIP) from Hall effect sensor 118 (or other type) coupled to crankshaft 40; throttle position (TP) from a throttle position sensor; and absolute manifold pressure signal, MAP, from sensor 122. Engine speed signal, RPM, may be generated by controller 12 from signal PIP. Manifold pressure signal MAP from a manifold pressure sensor may be used to provide an indication of vacuum, or pressure, in the intake manifold.

As described above, FIG. 1 shows only one cylinder of a multi-cylinder engine, and that each cylinder may similarly include its own set of intake/exhaust valves, fuel injector, spark plug, etc.

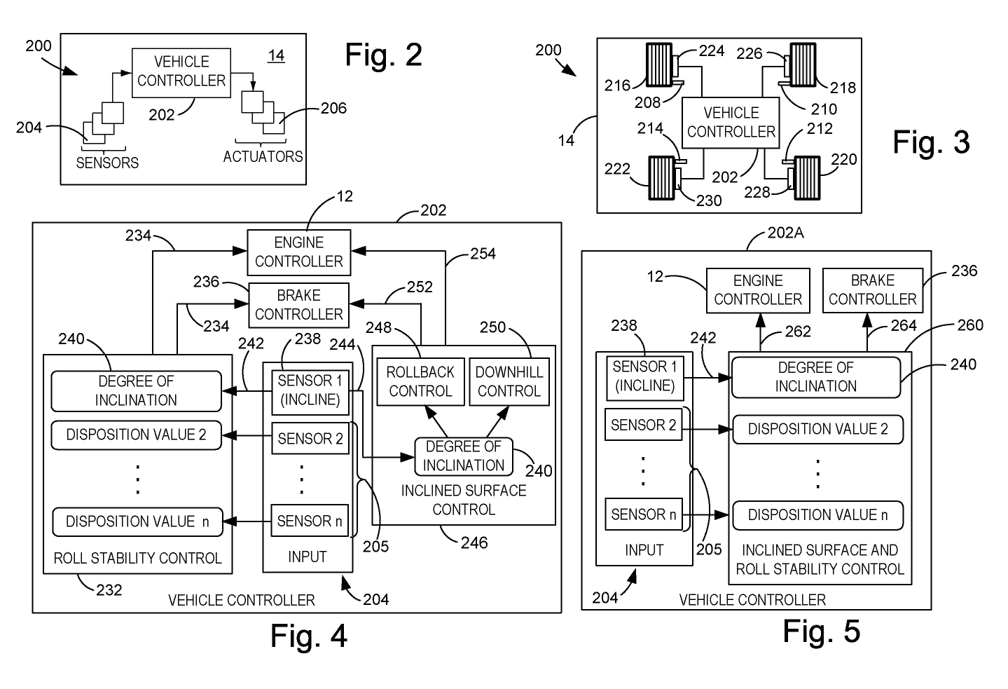

FIG. 2 is a schematic drawing illustrating generically a vehicle control system 200 that may include the engine 10 illustrated in FIG. 1. The vehicle control system 200 may include a vehicle controller 202 that may be coupled with a number of sensors 204 that may be configured to provide input regarding the disposition of the vehicle 14. Based on the input received, the vehicle control system 200 may also be configured to provide some control of the vehicle 14 via a number of actuators 206. For example, the sensors 204 may include one or more acceleration sensors, wheel speed sensors, a steering wheel position sensor, a yaw sensor, an inclination sensor, and the like. The actuators 206 may include, for example, wheel brake mechanisms and a throttle control, and the like.

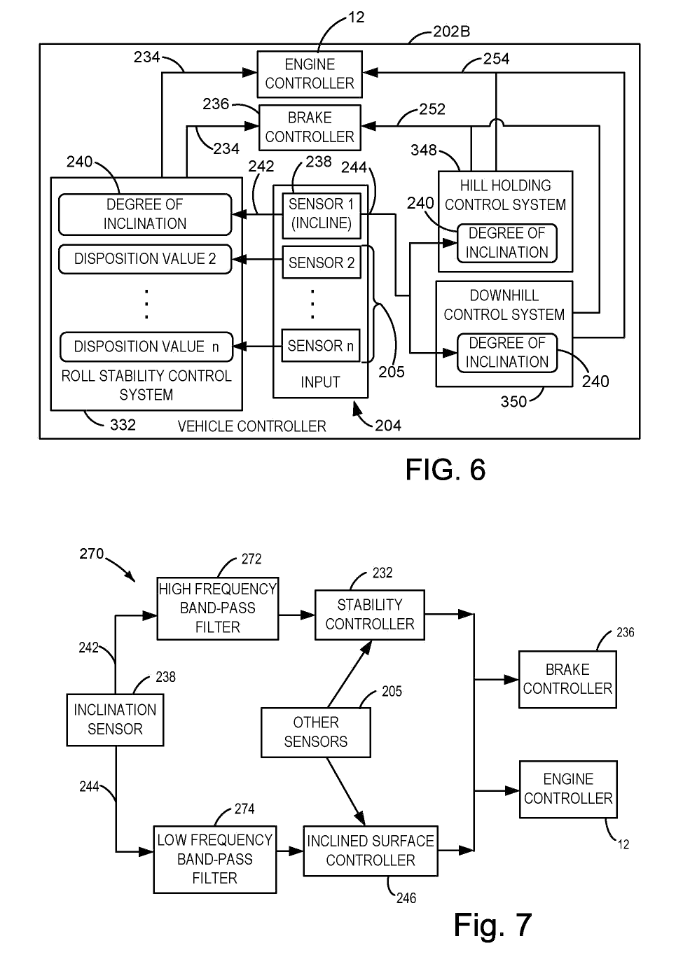

FIG. 3 is a schematic drawing illustrating the control system 200 coupled with some components of the vehicle 14. Wheels 216, 218, 220, and 222 may be coupled to, and may be propelled by, the engine 10 (FIG. 1). Brake mechanisms 224, 226, 228, and 230 may be respectively coupled to each wheel 216, 218, 220, and 222, and may be configured to slow or stop rotation of the wheels 216, 218, 220, and 222. Wheel speed sensors 208, 210, 212, and 214 may be respectively coupled to each wheel 216, 218, 220, and 222, of the vehicle. The wheel speed sensors 208, 210, 212, and 214 may be configured to measure the rotational speed of each individual wheel 216, 218, 220, and 222. The wheel brake mechanisms 224, 226, 228, and 230 may be actuated via electronic signals from the vehicle controller 202. In this example, the wheel brake mechanisms 224, 226, 228, and 230 may include actuators (not shown), pads (not shown), rotors (not shown), etc. In other examples, other suitable wheel braking mechanisms may be utilized.

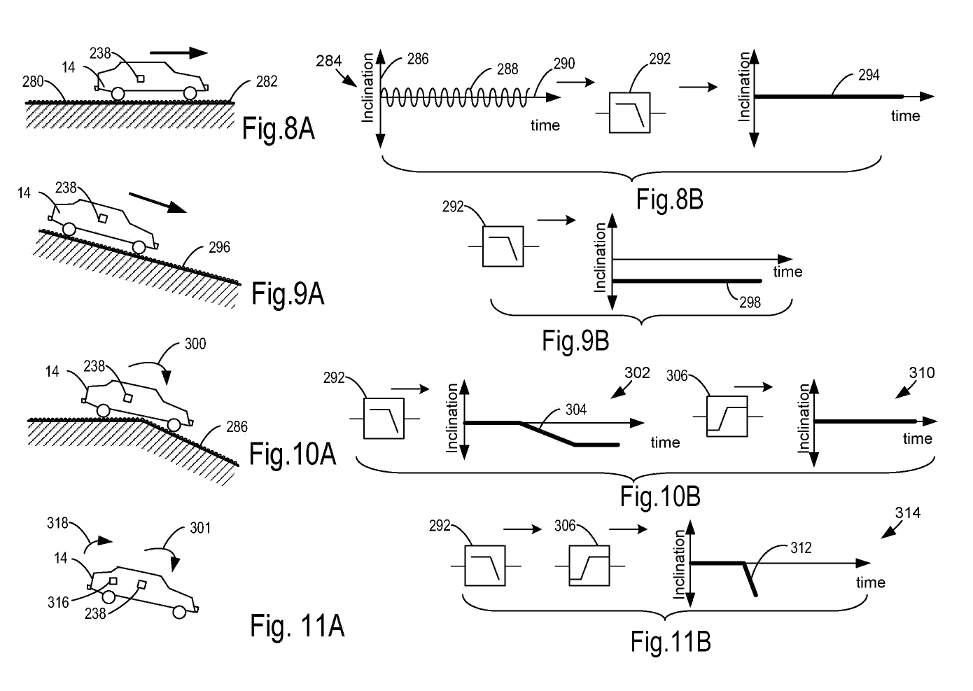

FIG. 4 is a schematic drawing illustrating details of an example vehicle controller 202 in accordance with various embodiments. The vehicle controller 202 may be part of the control system 200 for controlling the vehicle 14 as discussed above. The vehicle controller 202 may include a roll stability control (RSC) 232 configured to receive input from one or more of the sensors 204 and to provide RSC output signals 234 to a brake controller 236 and/or to the engine controller 12. The brake controller 236 may be operatively coupled with the brake mechanisms 224, 226, 228, and 230 (FIG. 3) to stop or slow one or more of the wheels 216, 218, 220, and 222. The one or more sensors 204 may include a vehicle inclination sensor 238, such as an acceleration sensor, that may be configured to detect a degree of inclination 240 of the vehicle 14 and to provide a first output signal 242 to the roll stability control 232 indicative of a degree of inclination 240 of the vehicle 14.

Other sensors 205, i.e. sensor 2 through sensor n, may be configured to measure various aspects of the disposition of the vehicle 14 by measuring various disposition values, i.e. disposition value 2 through disposition value n. For example, one or more of the other sensors 205 may be a lateral acceleration sensor. The lateral acceleration sensor may be configured to measure the lateral acceleration of the vehicle 14. Additionally, as another example, a longitudinal acceleration sensor may be configured to measure the longitudinal acceleration of the vehicle 14. Without limitation, other sensors configured to measure other disposition values may be included.

The RSC 232 may be configured to adjust the various actuators 206 to maintain the vehicle 14 on the driver's intended course. The sensors 204 may measure various vehicle operating conditions, and may determine the intended course and the actual course of the vehicle. In response to a disparity between the intended course and actual course, the RSC 232 may actuate various mechanisms in the vehicle, allowing the vehicle to maintain the intended course. The mechanisms may include the brake mechanisms 224, 226, 228, and 230, and the throttle 62 (FIG. 1), as well as the fuel delivery system, and combinations thereof.

In one specific example, the actual vehicle motion may be measured via a lateral acceleration, yaw, and/or wheel speed measurement. The intended course may be measured by a steering angle sensor that may be included with the sensors 204. The RSC 232 may take actions to correct under-steer or over-steer.

Alternatively, even when the vehicle is following a desired course, the RSC 232 may take corrective action to increase the vehicle's stability. For example, the RSC 232 may determine if one or more wheels of the vehicle may loose contact with the road due to an increase in lateral acceleration. If so, the RSC 232 may brake one or more wheels and/or decrease the power produced by the engine 10, and delivered to the wheels 216, 218, 220, and 222.

The vehicle inclination sensor 238 may be further configured to provide a second output signal 244 to an inclined surface control 246. The inclined surface control 246 may include a rollback control module 248, configured to prevent vehicle rollback and/or a downhill control module 250 configured to provide downhill control of the vehicle 14.

The rollback control 248 may be configured to receive the second output signal 244, and to provide a brake output signal 252 to the brake controller 236 to activate the brake mechanisms 224, 226, 228, and 230 for an amount of time, and/or an amount of brake pressure, sufficient for the engine 10 to exert enough torque to propel the vehicle 14 up an incline without any substantial rollback. The amount of time, and/or an amount of brake pressure, may be determined by the degree of inclination 240 as determined by the vehicle inclination sensor 238.

The downhill control module 250 may also be configured to receive the second output signal 244. The downhill control module 250 may also provide the brake output signal 252 to the brake controller 236 to activate the brake mechanisms 224, 226, 228, and 230 and/or to provide an engine control output signal 254 to the engine controller 12 to slow the vehicle when, for example, the vehicle inclination sensor 238 passes the second signal 244 that indicates the vehicle is on an incline greater than a predetermined value, and/or the wheel sensors 208, 210, 212, 214 indicates a vehicle speed greater than a predetermined speed.

FIG. 5 is a schematic drawing illustrating another example vehicle controller 202A in accordance with various embodiments. This example vehicle controller 202′ includes a combined inclined surface and stability controller 260. The combined inclined surface and stability controller 260 may be configured receive a signal 242 from a vehicle inclination sensor 238 to provide either roll stability control or inclined surface control depending on, for example, the disposition of the vehicle 14. The combined inclined surface and stability controller 260 may provide control of the vehicle via signal lines 262 and/or 264.

Various embodiments may provide a system 200 for an engine propelled vehicle. The system 200 may include a vehicle inclination sensor 238 configured to detect an inclination of the vehicle 14 and to provide an inclination output signal 242 to a roll stability control 232. The roll stability control 232 may be configured to provide at least brake and throttle control to effect improved vehicle stability control. The vehicle inclination sensor 238 may also be further configured to provide the inclination output signal to prevent vehicle rollback or provide downhill control of the vehicle.

FIG. 6 is a schematic drawing illustrating another example vehicle controller 202B in accordance with various embodiments that may be included as part of the system 200 shown in FIGS. 2 and 3. The system 200 may be for an engine propelled vehicle 14 and may include a vehicle inclination sensor 238 configured to detect an inclination of the vehicle 14. The system 200 may also include a roll stability control system 332 configured to provide at least brake and throttle control to effect improved vehicle stability control based on the vehicle inclination sensor 238. The system 200 may also include a hill holding control system 348 configured to provide at least engine, transmission, and wheel brake control to reduce vehicle rollback on inclined road surfaces based on the vehicle inclination sensor 238. The system 200 may further include a downhill control system 350 configured to provide at least engine, transmission, and wheel brake control to limit vehicle travel on declined road surface; based on the inclination sensor 238.

In various embodiments, two or more of the roll stability control system 332, the hill holding control system 348, and the downhill control system 350 may be integrated into a single controller. For example, all three of the roll stability control system 332, the hill holding control system 348, and the downhill control system 350 may be integrated into a single controller. In other embodiments all three of the roll stability control system 332, the hill holding control system 348, and the downhill control system 350 may be provided in separate controllers.

In some embodiments specific characteristics of the signal may be filtered using one or more band pass filters. In this way the same vehicle inclination sensor may be used for multiple purposes, and the signal from the common vehicle inclination sensor may be filtered in an efficient way to ensure the proper part of the signal is used respectively for inclined surface control, and for RSC.

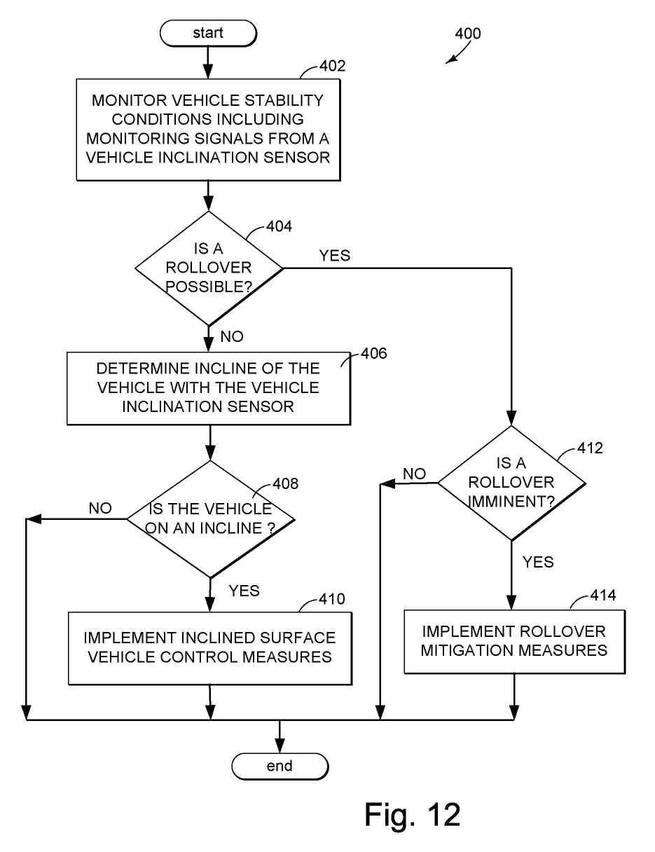

FIG. 7 is a schematic flow diagram 270 illustrating example ways a signal 242, 244 from the vehicle inclination sensor 238 may be conditioned according to various embodiments. In a first case the signal 242 may be passed through a high frequency band-pass filter 272 before being passed to the roll stability control 232 to filter out signals below a predetermined frequency. The filtered signal may effect corresponding actuation of the brake 236 controller and/or engine controller 12 as discussed. Signals from the other sensors 205 may also be used by the roll stability control 232 to determine, or to be included in the determination of, the disposition of the vehicle 14.

In a second case the signal 244 may be passed through a low frequency band-pass filter 274 before being passed to the inclined surface control 246 to filter out signals above a predetermined frequency. Signals from the other sensors 205 may also be used by the inclined surface controller 246 to determine, or to be included in the determination of, the disposition of the vehicle. Other cases are also possible.

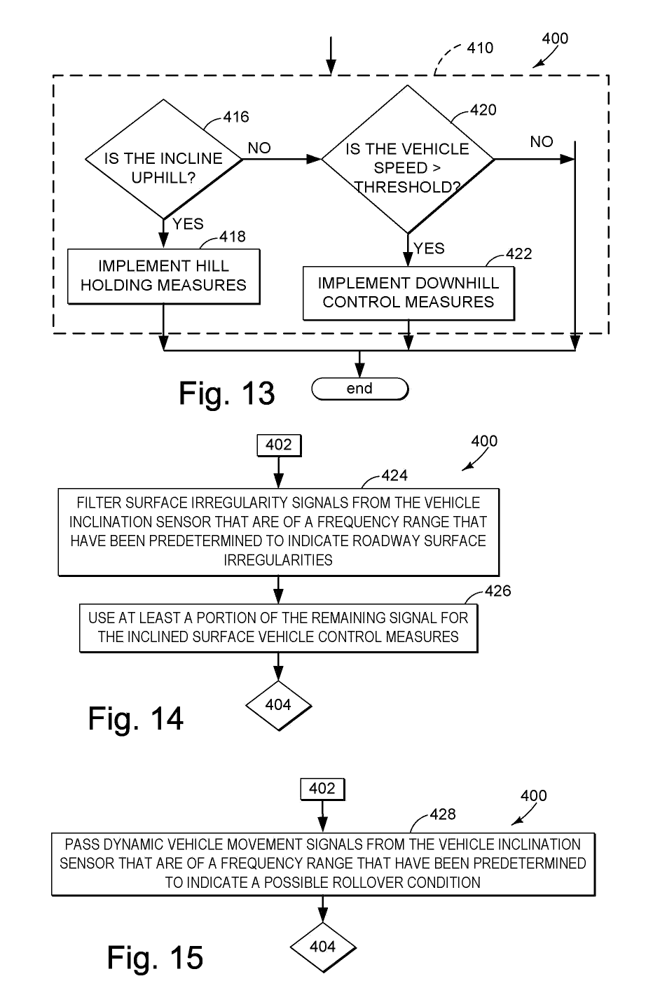

FIGS. 8A through 11B are pairs of figures illustrating example driving conditions schematically as inputs, and example signal outputs in graphical form. FIG. 8A illustrates a vehicle 14 traveling on a substantially horizontal surface 280 having a surface roughness 282. The vehicle 14 may include a vehicle inclination sensor 238 in accordance with the present disclosure. As discussed the vehicle inclination sensor 238 may be an accelerometer. The vehicle inclination sensor 238 may be located in various locations on the vehicle. For example, the vehicle inclination sensor 238 may be located, for example mounted on, the engine, the transmission, or the body of the vehicle. Turning now to FIG. 8B an output 284 from the vehicle inclination sensor 238 is illustrated in graphical form wherein a measured inclination is illustrated on a vertical axis 286, and wherein the inclination signal 288 is plotted over time on the horizontal axis 290. The inclination signal 288 exhibits rapid value changes which may be indicative of a high frequency input caused by the surface roughness 282. This inclination signal 288, however, may not warrant a response from the roll stability control 232 or the inclined surface control 246. The signal may be conditioned with a first band pass filter 292 to filter out the high frequency portion of the inclination signal 288 such that a filtered signal 294 may instead be passed to the roll stability control 232 and/or the inclined surface control 246.

FIG. 9A illustrates a vehicle 14 travelling on, or sitting unmoving on, a surface of constant inclination 296. As shown in FIG. 9B, the signal outputted from the vehicle inclination sensor 238 may be filtered with filter 292 to eliminate the portion of the signal that may be from a surface having a roughness below a predetermine threshold. The resultant signal 298 may indicate a constant negative incline. Such a signal may indicate that the vehicle 14 is not in a rollover condition. But, it may indicate that the inclined surface control 246 may use the resultant signal to implement downhill control.

FIG. 10A illustrates a vehicle 14 travelling on a surface of changing incline. The vehicle may pitch forward rapidly as indicated with arrow 300. A resultant signal 302 may be plotted to include a sloped portion 302 indicating the rapid pitch forward. However, the slope, and therefore the pitch, may be below a predetermined threshold indicating that the vehicle is not experiencing a rollover condition. Before being passed to the roll stability control 232 the signal 302 may be filtered out with second filter 306. The resultant signal 308 as plotted in plot 310 may be below a predetermined value to indicate a rollover condition.

FIG. 11A illustrates a vehicle experiencing an even more rapid pitch 301 forward than that illustrated in FIG. 10A. The vehicle may be experiencing a rollover condition. The signal from the vehicle inclination sensor 238 may be filtered with one or more filters, for example the low frequency band-pass filter 292 configured to pass signals lower than signals that may tend to indicate a rough driving surface, and the high band-pass filter 306 configured to pass dynamic vehicle movement signals that may tend to indicate a rollover condition. The resultant signal resultant signal 312 as plotted in plot 314 may be within a predetermined value to indicate a rollover condition.

FIG. 11A also schematically illustrates one or more additional sensors 316 that may sense, for example, an additional vehicle disposition value, for example transverse acceleration 318, or yaw, or the like, that may be used by the roll stability control 232 to determine if measure should be taken to mitigate a possible rollover. The one or more additional sensors 316 may be located in various locations on the vehicle. For example, they may be located, for example mounted on, the engine, the transmission, or the body of the vehicle. The additional vehicle disposition sensors may be configured to recognize when the vehicle is in a possible rollover condition as a first mode and to recognize when the vehicle is not in a possible rollover condition as a second mode. The system according to various embodiments may be configured to utilize the inclination output signal for the first mode before utilizing the inclination output signal for the second mode. In this way the default, or controlling, action to be taken by the system may be predetermined to be rollover mitigation. Other controlling conditions, or modes, may be predetermined.

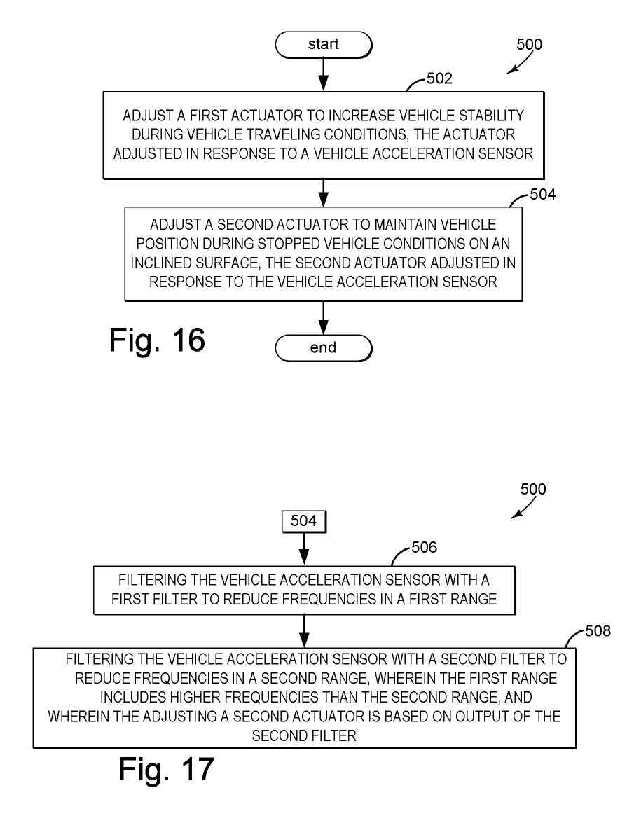

FIG. 12 is a flow chart illustrating a method 400 that may be implemented to control vehicle stability and to provide vehicle control on an incline in response to a vehicle inclination determined by one or more vehicle inclination sensors. Method 400 may be implemented via the components and systems described above, but alternatively may be implemented using other suitable vehicle components. Method 400 may include, at 402, monitoring vehicle stability conditions of the vehicle including signals from a vehicle inclination sensor. The method 400 may include, at 404, determining from the vehicle stability conditions if a rollover of the vehicle is possible. Then in a case wherein rollover is not possible, at 406, determining from the vehicle inclination sensor if the vehicle is on an incline. Then, as may be determined at decision box 408, in the case wherein a rollover is not possible and in a case wherein the vehicle is on an incline, at 410 implementing inclined surface vehicle control measures.

The method 400 may also include, as may have been determined at decision box 404, in the case wherein a rollover is possible, as may be determined at decision box 412, determining if a rollover is imminent, and wherein if a rollover is imminent then, at 414, implementing rollover mitigation measures.

FIG. 13 is a flow chart illustrating an example variation of the method 400. The inclined surface vehicle control measures, at 410 in FIG. 12, may include, determining, at decision box 416 a direction of the incline, then, in the case of an uphill incline, at 418, implementing hill holding measures. The hill holding measures may include activating a brake in the case of an uphill incline an amount of time sufficient for the engine to exert enough torque to propel the vehicle up the incline without any substantial rollback of the vehicle. However, in the case of a downhill incline determining, at 420, if the vehicle speed is greater than a predetermined threshold. If the incline is greater than the predetermined threshold then the method 400 may include, at 422, implementing downhill control measures. The downhill control measures may include activating a brake in the case of a downhill incline an amount to keep the vehicle below a predetermined speed, and/or reducing engine torque. If the vehicle speed is not greater than the predetermined threshold, then the method may end, and may start again at 402.

FIG. 14 is a flow chart illustrating an example variation of the method 400. In various embodiments the method 400 may include, at 424 filtering surface irregularity signals from the vehicle inclination sensor that are of a frequency range that have been predetermined to indicate roadway surface irregularities. The method 400 may include, at 426, using at least a portion of the remaining signal for the inclined surface vehicle control measures.

FIG. 15 is a flow chart illustrating an example variation of the method 400. In various embodiments the method 400 may include, at 428, passing dynamic vehicle movement signals from the vehicle inclination sensor that are of a frequency range that have been predetermined to indicate a possible rollover condition.

FIG. 16 is a flow chart illustrating another method 500 of controlling a vehicle. The method 500 may include, at 502, adjusting a first actuator to increase vehicle stability during vehicle traveling conditions, the actuator may be adjusted in response to a vehicle acceleration sensor. The method may also include, at 504, adjusting a second actuator to maintain vehicle position during stopped vehicle conditions on an inclined surface, the second actuator adjusted in response to the vehicle acceleration sensor.

In some embodiments the first actuator and the second actuator may be the same actuator. The actuators may be configured to actuate one or more brake mechanisms. In some embodiments, the vehicle acceleration sensor may be a longitudinal accelerometer.

FIG. 17 is a flow chart illustrating an example variation of the method 500. The method 500 may include, at 506, filtering the vehicle acceleration sensor with a first filter to reduce frequencies in a first range. The method 500 may also include, at 508, filtering the vehicle acceleration sensor with a second filter to reduce frequencies in a second range. The first range may include higher frequencies than the second range, and the adjusting a second actuator may be based on output of the second filter.

The first actuator may be configured to reduce a rollover tendency of the vehicle. The method 500 may also include adjusting a third actuator during vehicle travel on a declined surface to limit acceleration of the vehicle.

In some embodiments, the adjusting a second actuator to maintain vehicle position may include applying a brake to wheels of the vehicle with a selected brake pressure based on a degree of inclination as indicated by the vehicle acceleration sensor. Also, or alternatively, in some embodiments, the adjusting a second actuator to maintain vehicle position may include applying a brake to wheels of the vehicle for a selected amount of time based on a degree of inclination as indicated by the vehicle acceleration sensor. Also, or alternatively, in some embodiments, the adjusting a second actuator to maintain vehicle position may include increasing engine torque based on a degree of inclination as indicated by the vehicle acceleration sensor.

In some embodiments the method 500 may also include filtering road noise from a signal from the vehicle acceleration sensor. In this way the signal from the vehicle acceleration sensor may more accurately reflect the relevant data for use by the particular control feature.

Note that the example controls and routines included herein can be used with various engine and/or vehicle system configurations. The specific routines described herein may represent one or more of any number of processing strategies such as event-driven, interrupt-driven, multi-tasking, multi-threading, and the like. As such, various acts, operations, or functions illustrated may be performed in the sequence illustrated, in parallel, or in some cases omitted. Likewise, the order of processing is not necessarily required to achieve the features and advantages of the example embodiments described herein, but is provided for ease of illustration and description. One or more of the illustrated acts or functions may be repeatedly performed depending on the particular strategy being used. Further, the described acts may graphically represent code to be programmed into the computer readable storage medium in the engine control system.

It will be appreciated that the configurations and routines disclosed herein are exemplary in nature, and that these specific embodiments are not to be considered in a limiting sense, because numerous variations are possible. The subject matter of the present disclosure includes all novel and nonobvious combinations and subcombinations of the various systems and configurations, and other features, functions, and/or properties disclosed herein.

The following claims particularly point out certain combinations and subcombinations regarded as novel and nonobvious. These claims may refer to “an” element or “a first” element or the equivalent thereof. Such claims should be understood to include incorporation of one or more such elements, neither requiring nor excluding two or more such elements. Other combinations and subcombinations of the disclosed features, functions, elements, and/or properties may be claimed through amendment of the present claims or through presentation of new claims in this or a related application. Such claims, whether broader, narrower, equal, or different in scope to the original claims, also are regarded as included within the subject matter of the present disclosure.

1. A method of controlling a vehicle, comprising:
adjusting a first actuator to increase vehicle stability during vehicle traveling conditions, the actuator adjusted in response to a vehicle acceleration sensor;
adjusting a second actuator to maintain vehicle position during stopped vehicle conditions on an inclined surface, the second actuator adjusted in response to the vehicle acceleration sensor.

2. The method of claim 1, wherein the first actuator and the second actuator are the same actuator.

3. The method of claim 1, wherein the first actuator and the second actuator are the same actuator configured to actuate one or more brake mechanisms.

4. The method of claim 1, wherein the vehicle acceleration sensor is a longitudinal accelerometer.

5. The method of claim 1, further comprising:
filtering the vehicle acceleration sensor with a first filter to reduce frequencies in a first range;
filtering the vehicle acceleration sensor with a second filter to reduce frequencies in a second range, wherein the first range includes higher frequencies than the second range, and wherein the adjusting a second actuator is based on output of the second filter.

6. The method of claim 5, wherein the adjusting a first actuator is configured to reduce a rollover tendency of the vehicle.

7. The method of claim 1, further comprising:
adjusting a third actuator during vehicle travel on a declined surface to limit acceleration of the vehicle.

8. The method of claim 1, wherein the adjusting a second actuator to maintain vehicle position includes applying a brake to wheels of the vehicle with a selected brake pressure based on a degree of inclination as indicated by the vehicle acceleration sensor.

9. The method of claim 1, wherein the adjusting a second actuator to maintain vehicle position includes applying a brake to wheels of the vehicle for a selected amount of time based on a degree of inclination as indicated by the vehicle acceleration sensor.

10. The method of claim 1, wherein the adjusting a second actuator to maintain vehicle position includes increasing engine torque based on a degree of inclination as indicated by the vehicle acceleration sensor.

11. The method of claim 1, further comprising filtering road noise from a signal from the vehicle acceleration sensor.

12. A system for an engine propelled vehicle comprising:
a vehicle inclination sensor configured to detect an inclination of the vehicle;
a roll stability control system configured to provide at least brake and throttle control to effect improved vehicle stability control based on the vehicle inclination sensor; and
a hill holding control system configured to provide at least engine, transmission, and wheel brake control to reduce vehicle rollback on inclined road surfaces based on the vehicle inclination sensor; and
a downhill control system configured to provide at least engine, transmission, and wheel brake control to limit vehicle travel on declined road surface; based on the inclination sensor.

13. The system of claim 12, wherein two or more of the roll stability control system, the hill holding control system, and the downhill control system are integrated into a single controller.

14. The system of claim 12, wherein all three of the roll stability control system, the hill holding control system, and the downhill control system are integrated into a single controller.

15. The system of claim 12, wherein all three of the roll stability control system, the hill holding control system, and the downhill control system are provided in separate controllers.

16. The system of claim 12, wherein the vehicle inclination sensor is a longitudinal acceleration sensor.

17. The system of claim 12, wherein the roll stability control system, the hill holding control system, and the downhill control system each include filters, all of the filters being configured to pass signals with a different frequency content such that the roll stability control system is configured to utilize a relatively higher frequency content, and the hill holding control system, and the downhill control system are configured to utilize a relatively lower frequency content.

18. The system of claim 12, wherein the hill holding system is configured to increase a braking pressure and to increase a starting engine torque in accordance with an increased inclination as measured by the vehicle inclination sensor.

19. The system of claim 12, wherein the downhill control system is configured to increase a braking pressure and to decrease an engine torque in accordance with an increased declination as measured by the vehicle inclination sensor.

20. The system of claim 12, wherein the roll stability control system is configured to provide the at least brake and throttle control to reduce a roll tendency of the vehicle by providing a controlled vehicle rolling torque opposite to a sensed vehicle rolling torque.

21. A method to control the performance of an engine propelled vehicle comprising:
monitoring vehicle stability conditions of the vehicle including signals from a vehicle inclination sensor;
determining from the vehicle stability conditions if a rollover of the vehicle is possible;
in a case wherein rollover is not possible determining from the vehicle inclination sensor if the vehicle is on an incline; and
in the case wherein rollover is not possible and in a case wherein the vehicle is on an incline implementing inclined surface vehicle control measures.

22. The method of claim 21, further comprising, in the case wherein a rollover is possible further determining if a rollover is imminent, and wherein if a rollover is imminent then implementing rollover mitigation measures.

23. The method of claim 21, wherein the inclined surface vehicle control measures include activating a brake in the case of an uphill incline an amount of time sufficient for the engine to exert enough torque to propel the vehicle up the incline without any substantial rollback of the vehicle.
